(19) United States
(12) Patent Application Publication
(10) Pub. No.: US 2009/0283733 A1
(43) Pub. Date: Nov. 19, 2009

(54) SAFETY JACK SYSTEM

(76) Inventors: DANIEL LYASHEVSKIY, BATTLE GROUND, WA (US); YURIY LYASHEVKIY, APISON, TN (US)

Correspondence Address: RYLANDER & ASSOCIATES PC, 406 WEST 12TH STREET, VANCOUVER, WA, 98660, US

(21) Appl. No.: 12/465,399

(22) Filed: May 13, 2009

Related U.S. Application Data
(60) Provisional application No. 61/053,025, filed on May 14, 2008.
(60) Provisional application No. 61/110,826, filed on Nov. 3, 2008.

(51) Int. Cl. B66F 5/00

(52) U.S. Cl. 254/5 R

(57) ABSTRACT

An improved safety jack system includes a jack, a locking arm base coupled to the jack base having a linear guide pivotably coupled to the jack base, a releasable locking mechanism engagable with a locking arm, a release operator coupled to the releasable locking mechanism, a locking arm with a plurality of engagement points distributed along at least a portion of the locking arm movably connectable to the linear guide and pivotably connectable to the jack head. An improved jack system includes a remote release operator and a locking mechanism biasing element coupled to the releasable locking mechanism. An improved safety jack system includes a removably connected jack base extension.

### CROSS-REFERENCE TO RELATED APPLICATION

This application is claims priority to U.S. Provisional Patent Application Ser. No. 61/053,025, filed 14 May 2008, and U.S. Provisional Patent Application Ser. No. 61/110,826, filed Nov. 3, 2008, the teachings of both of which are hereby incorporated by reference.

### FIELD OF THE INVENTION

The present invention relates to an improved jack system.

### BACKGROUND

Mechanical and hydraulic jacks are known, including portable or mobile jacks for lifting vehicles and industrial equipment. Dangers associated with such jacks are also known. Jacks are subject to any number of failure modes, for example tipping caused by lateral instability or simply collapsing due to structural failure of a component. Generally, proper safety precautions require that, prior to a person working underneath a vehicle or piece of equipment which has been jacked up, jack stands or blocks or a similar locked device (hereinafter referred to generally as “blocks”) must be placed under the load and the jack lowered to shift the load to the blocks. However, until the blocks are placed the load remains unstable and the jack or jacks remain subject to failure and the persons positioning under the blocks are in danger from a jack failure.

FIG. 2 is illustrative of a type of prior art mechanical jack, which lacks an inherently safe locking arm to prevent collapse.

A mechanical jack is a device that lifts and/or moves heavy equipment. A common mechanical jack is a car jack (also called a floor jack or garage jack) that may be used to lift vehicles to perform maintenance (e.g., changing tires, changing oil, or other routine preventative and/or emergency maintenance tasks). Car jacks usually use mechanical advantage to allow a human to lift a vehicle by manual force alone. Such an example is a screw jack as is known in the art. More powerful jacks (i.e., those capable of lifting and/or moving heavier objects) may use hydraulic power to provide more lift over greater distances. A common hydraulic car jack may have a two or four ton capacity with travel distances between six and twenty-four inches.

FIG. 4 illustrates that once a vehicle is jacked to a particular height using the prior art jack 210, a jack stand must be used (i.e., inserted between the vehicle frame, axle, or other vehicle hard point and the floor) to carry the load because the mechanical jack may not be relied on to carry the load for extended periods and with dynamic forces acting on the load (i.e. from the maintenance operations on the car). Jack stands are generally height adjustable and have load capacity ratings similar to the jacks they complement and/or supplement. Both the American Society of Mechanical Engineers and the American National Standards Institute publish standards regarding safe jack stand specifications and operation.

Though one or more jack stands may improve the safety with which a mechanic or other jack user may, for example, perform maintenance on a vehicle, the mechanic or other jack user must manually insert the jack stand or stands once the vehicle has been jacked to a desired height. While doing so, the mechanic or other jack user is exposed to the danger of jack failure, and there is a danger of collapse during the jacking operation itself. Additionally, this process must be repeated when lowering the load after maintenance: the operator must jack the load off of jack stand, then go under the suspended load to remove the jack stands, then lower the load using the jack. Further, the hard point on the vehicle frame or the like at which the vehicle is best jacked may not be simultaneously available for the jack stand. Thus, there is a need for an improved mechanical jack which is inherently safe, such that it may fill the purpose of a jack and a jack stand, thereby improving safety and efficiency.

Thus, there is a need for an improved safety jack system which includes the following features: (1) substantially prevents unintentional or inadvertent jack lowering and/or release thereby increasing the safety with jacks may be operated; (2) obviates the need for simultaneous use of a jack and one or more jack stands; (3) obviates the need for multiple hard points for each of the jack and a jack stand; (4) allows the release of the jack locking mechanism from a location not underneath the vehicle or the like; (5) allows a user to lift and lower a vehicle to user selected heights and lock the vehicle at the selected height with one apparatus thereby improving time and efficiency; (6) allows a user to lift, set, and lower a load from a single safe location without the need to operate under the suspended load to set or remove safety devices; (7) allows a user to convert an existing jack to an inherently safe locking jack; (8) provides an inherently safe jack system which can be broken down for storage or transport; and (9) is inherently safe such that it supports the jack and the load in a locked position without further operation by the user.

### SUMMARY AND ADVANTAGES

A mechanical jack including a locking mechanism to substantially secure the mechanical jack at a jack height. The jack of an embodiment further includes a locking mechanism release to release the locking mechanism.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

An improved safety jack system includes a jack having a base, an operator, a head, and a movable jack arm having a first end connected to the jack base and a second end connected to the jack head, a locking arm base coupled to the jack base, the locking arm base comprising: a linear guide pivotably coupled to the jack base, a releasable locking mechanism engagable with a locking arm, and a release operator coupled to the releasable locking mechanism, and, a locking arm having first and second ends and a plurality of locking mechanism engagement points distributed along at least a portion of the locking arm, the locking arm movably connectable at the first end to the linear guide and pivotably connectable at the second end to the jack head. An improved jack system may include a remote release operator having a first end coupled to the release operator and a second end located proximal to the jack operator. An improved jack system may include wherein the releasable locking mechanism includes a pawl and the plurality of locking mechanism engagement points include a plurality of locking teeth. An improved jack system may include a locking mechanism biasing element coupled to the releasable locking mechanism. An improved jack system may include wherein the biasing element comprises a spring coupled between the release operator and the locking arm base.

An improved safety jack system may include a locking arm for a jack, the jack a jack including a base, an operator, a head, and a movable jack arm having a first end connected to the jack base and a second end connected to the jack head, a locking arm base couplable to the jack base, the locking arm base including a jack base extension removably connectable to the jack base, a linear guide pivotably coupled to the extension, a releasable locking mechanism engagable with a locking arm, a release operator coupled to the releasable locking mechanism, a locking arm having first and second ends and a plurality of locking mechanism engagement points distributed along at least a portion of the locking arm, the locking arm movably connectable at the first end to the linear guide and pivotably connectable at the second end to the jack head. A locking arm for a jack may include a remote release operator having a first end coupled to the release operator and a second end positionable proximal to the jack operator. A locking arm for a jack may include wherein the releasable locking mechanism includes a pawl and the plurality of locking mechanism engagement points include a plurality of locking teeth. A locking arm for a jack may include a locking mechanism biasing element coupled to the releasable locking mechanism. A locking arm for a jack may include wherein the biasing element includes a spring coupled between the release operator and a the locking arm base. A locking arm for a jack may include wherein the extension further includes at least one support roller.

An improved safety jack system may include a jack having a base, an operator, a head, and a movable jack arm having a first end connected to the jack base and a second end connected to the jack head, a locking arm base couplable to the jack base, the locking arm base including a jack base extension removably connectable to the jack base, the extension including at least one support roller, a linear guide pivotably coupled to the extension, a releasable locking mechanism engagable with a locking arm, a release operator coupled to the releasable locking mechanism, a locking mechanism biasing element coupled to the releasable locking mechanism, a remote release operator having a first end coupled to the release operator and a second end positionable proximal to the jack operator, a locking arm having first and second ends and a plurality of locking mechanism engagement points distributed along at least a portion of the locking arm, the locking arm movably connectable at the first end to the linear guide and pivotably connectable at the second end to the jack head. An improved safety jack system may include wherein the releasable locking mechanism includes a pawl and the plurality of locking mechanism engagement points include a plurality of locking teeth. An improved safety jack system may include wherein the biasing element includes a spring coupled between the release operator and a the locking arm base.

The improved safety jack system of the present invention presents numerous advantages, including: (1) substantially prevents unintentional or inadvertent jack lowering and/or release thereby increasing the safety with jacks may be operated; (2) obviates the need for simultaneous use of a jack and one or more jack stands; (3) obviates the need for multiple hard points for each of the jack and a jack stand; (4) allows the release of the jack locking mechanism from a location not underneath the vehicle or the like; (5) allows a user to lift and lower a vehicle to user selected heights and lock the vehicle at the selected height with one apparatus thereby improving time and efficiency; (6) allows a user to lift, set, and lower a load from a single safe location without the need to operate under the suspended load to set or remove safety devices; (7) allows a user to convert an existing jack to an inherently safe locking jack; (8) provides an inherently safe jack system which can be broken down for storage or transport; and, (9) is inherently safe such that it supports the jack and the load in a locked position without further operation by the user.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a first embodiment of an improved safety jack system.

FIG. 2 shows a prior art jack.

FIG. 3 shows the improved safety jack system of FIG. 1 in use.

FIG. 4 shows prior art jack of FIG. 2 including a prior art jack stand.

FIG. 5 shows top front view of a second embodiment.

FIG. 6 shows a top front perspective view of a second embodiment.

FIG. 7 shows a top front perspective view of a second embodiment.

FIG. 8 shows partial exploded view of a second embodiment.

FIG. 9 shows close up cutaway view of a locking arm base of a second embodiment.

### REFERENCE NUMBERS USED IN DRAWINGS

Turning now descriptively to the drawings, in which similar reference characters denote similar elements throughout the several views, the figures illustrate the ratcheting vehicle jack of an embodiment of the present invention. With regard to the reference numerals used, the following numbering is used throughout the various drawing figures:
110 Improved Safety Jack System
112 Jack
120 Jack Base
122 Roller
124 Support Roller
126 Support Roller
128 Support Roller
130 Jack Operator
140 Jack Arm
142 Jack Arm Pivot
144 Jack Head
146 Jack Arm First End
148 Jack Arm Second End
150 Locking Arm
152 Locking Arm Sleeve Coupling
153 Cotter Pin
154 Locking Teeth
156 Locking Arm First End
158 Locking Arm Second End
160 Locking Arm Base
162 Biasing Spring
164 Release Operator
166 Linear Guide
168 Locking Mechanism
170 Remote Release Operator
172 Remote Release Operator First End
174 Remote Release Operator Second End
176 Biasing Spring First End
178 Biasing Spring Second End
200 Prior Art Jack
210 Jack Stand
310 Second Embodiment of an Improved Safety Jack System
312 Jack
320 Jack Base
322 Support Roller
324 Support Roller
326 Support Roller
328 Support Roller
330 Jack Operator
332 Shaft Sleeve
340 Jack Arm
342 Jack Arm Pivot
344 Jack Head
346 Jack Arm First End
348 Jack Arm Second End
350 Locking Arm
352 Locking Arm Sleeve Coupling
353 Cotter Pin
354 Locking Teeth
356 Locking Arm First End
358 Locking Arm Second End
360 Locking Arm Base
362 Biasing Spring
364 Release Operator
366 Linear Guide
368 Locking Mechanism
370 Remote Release Operator
372 Remote Release Operator First End
374 Remote Release Operator Second End
376 Biasing Spring First End
378 Biasing Spring Second End
380 Locking Arm Base Extension
382 Linear Guide Sleeve Coupling
386 Base Extension Slot
388 Base Extension Slot
390 Removable Fasteners
392 Base Extension Support Roller
394 Base Extension Support Roller

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

An improved safety jack system includes a jack having a base, an operator, a head, and a movable jack arm having a first end connected to the jack base and a second end connected to the jack head, a locking arm base coupled to the jack base, the locking arm base comprising: a linear guide pivotably coupled to the jack base, a releasable locking mechanism engagable with a locking arm, and a release operator coupled to the releasable locking mechanism, and, a locking arm having first and second ends and a plurality of locking mechanism engagement points distributed along at least a portion of the locking arm, the locking arm movably connectable at the first end to the linear guide and pivotably connectable at the second end to the jack head. An improved jack system may include a remote release operator having a first end coupled to the release operator and a second end located proximal to the jack operator. An improved jack system may include wherein the releasable locking mechanism includes a pawl and the plurality of locking mechanism engagement points include a plurality of locking teeth. An improved jack system may include a locking mechanism biasing element coupled to the releasable locking mechanism. An improved jack system may include wherein the biasing element comprises a spring coupled between the release operator and the locking arm base.

An improved safety jack system may include a locking arm for a jack, the jack a jack including a base, an operator, a head, and a movable jack arm having a first end connected to the jack base and a second end connected to the jack head, a locking arm base couplable to the jack base, the locking arm base including a jack base extension removably connectable to the jack base, a linear guide pivotably coupled to the extension, a releasable locking mechanism engagable with a locking arm, a release operator coupled to the releasable locking mechanism, a locking arm having first and second ends and a plurality of locking mechanism engagement points distributed along at least a portion of the locking arm, the locking arm movably connectable at the first end to the linear guide and pivotably connectable at the second end to the jack head. A locking arm for a jack may include a remote release operator having a first end coupled to the release operator and a second end positionable proximal to the jack operator. A locking arm for a jack may include wherein the releasable locking mechanism includes a pawl and the plurality of locking mechanism engagement points include a plurality of locking teeth. A locking arm for a jack may include a locking mechanism biasing element coupled to the releasable locking mechanism. A locking arm for a jack may include wherein the biasing element includes a spring coupled between the release operator and a the locking arm base. A locking arm for a jack may include wherein the extension further includes at least one support roller.

An improved safety jack system may include a jack having a base, an operator, a head, and a movable jack arm having a first end connected to the jack base and a second end connected to the jack head, a locking arm base couplable to the jack base, the locking arm base including a jack base extension removably connectable to the jack base, the extension including at least one support roller, a linear guide pivotably coupled to the extension, a releasable locking mechanism engagable with a locking arm, a release operator coupled to the releasable locking mechanism, a locking mechanism biasing element coupled to the releasable locking mechanism, a remote release operator having a first end coupled to the release operator and a second end positionable proximal to the jack operator, a locking arm having first and second ends and a plurality of locking mechanism engagement points distributed along at least a portion of the locking arm, the locking arm movably connectable at the first end to the linear guide and pivotably connectable at the second end to the jack head. An improved safety jack system may include wherein the releasable locking mechanism includes a pawl and the plurality of locking mechanism engagement points include a plurality of locking teeth. An improved safety jack system may include wherein the biasing element includes a spring coupled between the release operator and a the locking arm base.

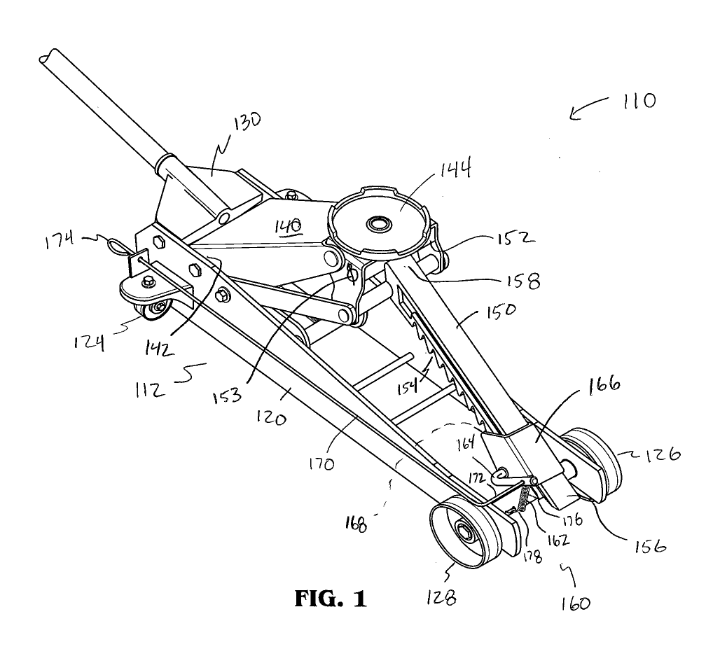

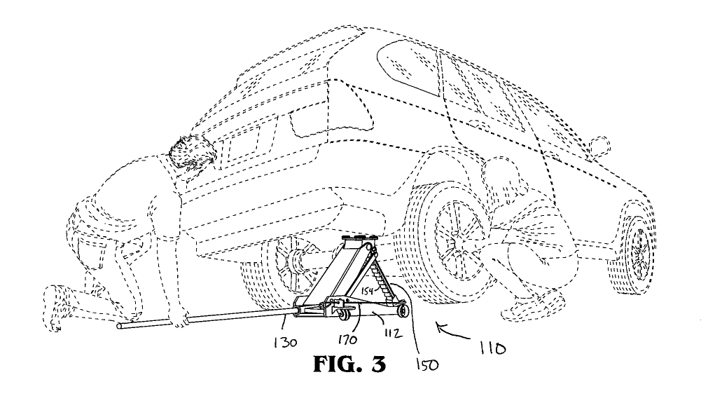

Referring to FIGS. 1 and 3, a first embodiment of an improved safety jack system 110 is provided. As shown in FIGS. 1 and 3, an improved safety jack system 110 is shown, including a jack 112 having a base 120, an operator 130, a head 144, and a movable jack arm 140 with first end 146 connected to jack base 120 and second end 148 connected to jack head 144.

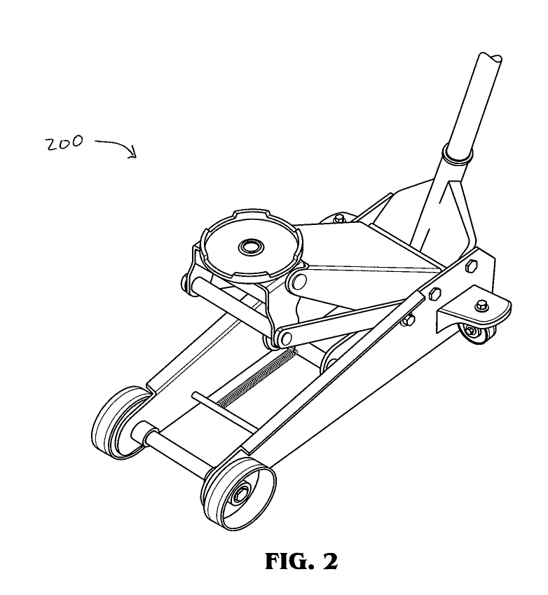

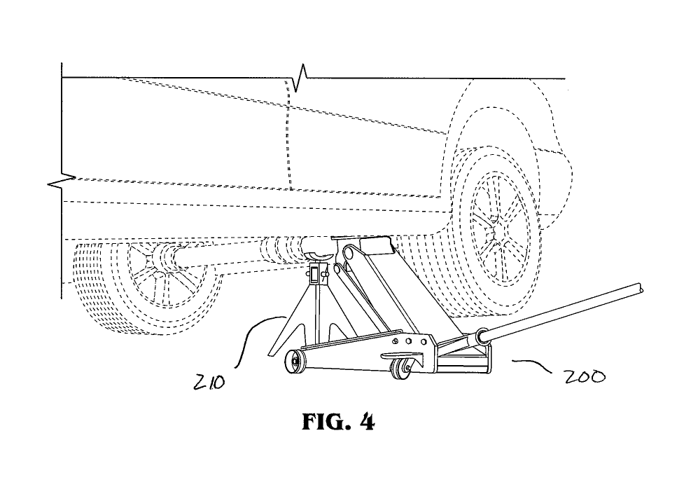

Unlike the prior art jack 200 illustrated by FIGS. 2 and 4 that includes a jack arm that substantially operates as a cantilever (i.e., it is supported by the jack base at only one end) and the additional jack stand 210 the jack 200 may require for safe support, the improved safety jack system 110 shown includes a locking arm 150 to add an additional degree of support to the jack arm 140, and which operates in an inherently safe manner—i.e. it automatically locks in place to prevent inadvertent collapse.

A locking arm base 160 is provided, which couples to jack base 120, the locking arm base 160 including a linear guide 166 pivotably coupled to the locking arm base 160, a releasable locking mechanism 168 engagable with a locking arm 150; a release operator 164 coupled to releasable locking mechanism 168, and a locking arm 150 having first and second ends, 156 and 158 respectively, and a plurality of locking mechanism engagement points 154 distributed along at least a portion of locking arm 150, with locking arm 150 movably connectable at first end 156 to linear guide 166 and pivotably connectable at second end 158 to jack head 144. Preferably locking arm 150 is straight for simplicity, but may be curved to prevent becoming jammed against the floor when used with shorter jacks. In the embodiment engagement points 154 are locking teeth for engaging a pawl or similar mechanical locking mechanism. Locking teeth 154 are distributed along at least a portion of the length of locking arm 150 to provide a range of selectable locking heights.

In the embodiment, linear guide 166 is a sleeve within which locking arm 150 slides during elevation or depression of jack arm 140. Locking arm first end 156 is pivotably connected to jack head 144 by sleeve coupling 152, which is coaxially mounted over cotter pin 153.

In the embodiment jack 112 is a cantilevered mechanical jack, base 120 includes an elongated support frame on rollers 122, 124, 126 and 128, operator 130 is an elongated handle accessible to the operator, and jack head 144 includes a plate for engaging the frame of a vehicle. In the embodiment, movable jack arm 144 is cantilevered so that it can recess into base 120 to lower the profile of the jack. Rollers 122 and 124 are preferably steerable.

Referring again to FIGS. 1 and 3, in an embodiment a remote release operator 170 is provided, having a first end 172 coupled to release operator 164 and a second end 174 located proximal to jack operator 130, allowing the user to operate the jack and the locking mechanism from a single location. In the embodiment, locking mechanism 168 is a pawl coaxially mounted with release operator 164 internally to linear guide 166, and locking mechanism engagement points 154 are teeth to engage pawl 168.

Referring against to FIGS. 1 and 3, locking mechanism 168 is preferably biased to the locked position by gravity, but biasing element 162 is provided to assist gravity, ensure proper seating, and prevent locking mechanism 168 from unlocking due to mechanical jarring. In the embodiment, biasing element 162 is a spring connected at a first end 176 to release operator 164 and at a second end 178 to an anchor point on locking arm base 160, which biases locking mechanism 168 in the engaged position to help ensure positive engagement between pawl 168 and teeth 154.

A user employing the improved safety jack system 110 of the first embodiment will first position the improved safety jack system 110 under a vehicle or piece of equipment to be raised. The user will thereafter rotate and/or twist the jack operator 130 to close the hydraulic piston valve before repeatedly depressing the jack operator 130 to raise and/or increase the height of the movable jack arm 140 to jack the vehicle or the like to a desired height. While the jack arm 140 rises, the locking teeth 154 of the locking arm 150 will be pulled through linear guide 166. Linear guide 166 will pivot about sleeve coupling 182 and locking arm sleeve coupling 152 will pivot about cotter pin 153 as the height of jack head 144 changes. Locking mechanism 168, which in the embodiment is a pawl will allow locking arm 150 to move only in the up direction, and automatically lock against locking teeth 154 to prevent downward movement, thereby creating an inherently safe system. Locking mechanism 168 is preferably gravity biased to the locked position, but biasing spring 162 ensures positive engagement and prevents inadvertent operation of release operator 164.

To lower the movable jack arm 140, the user will first disengage the locking mechanism 168 by raising the load slightly using the jack operator, then pulling remote release operator 170, which rotates release operator 164 against spring pressure, thereby rotating locking mechanism 168 away from the engaged locking teeth and allowing the jack to be lowered. The user will either repeat this sequence incrementally or may simply hold remote operator 170 in the release position while lowering the jack continuously.

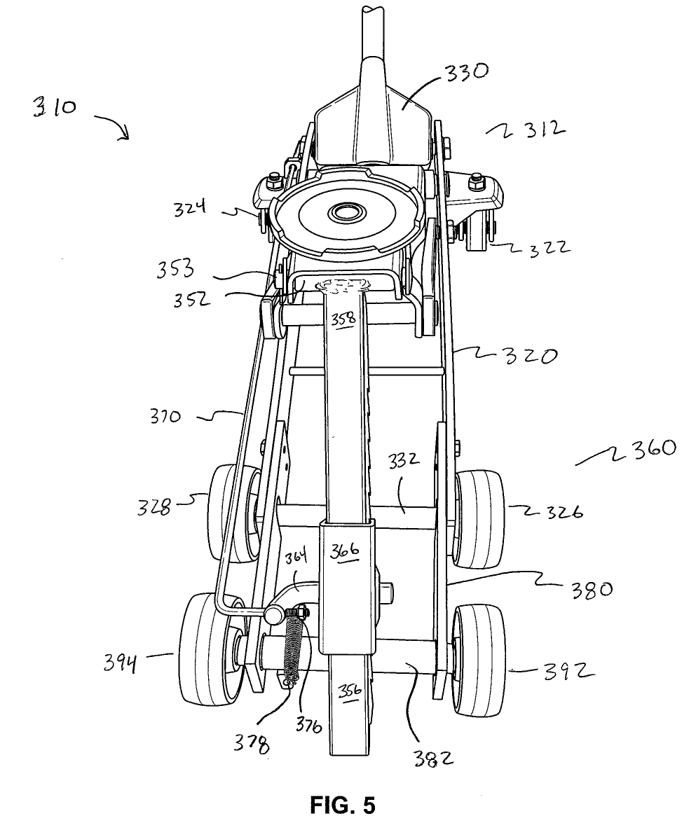

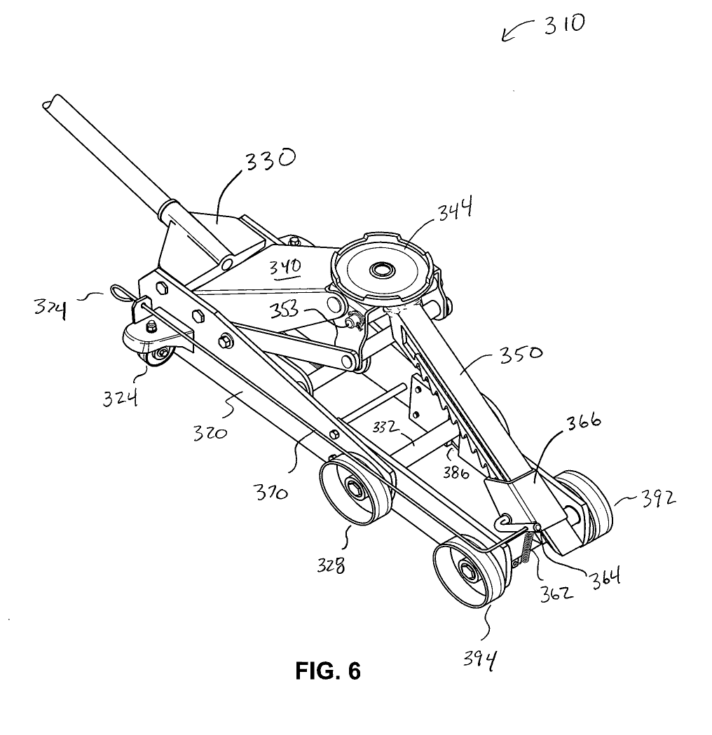

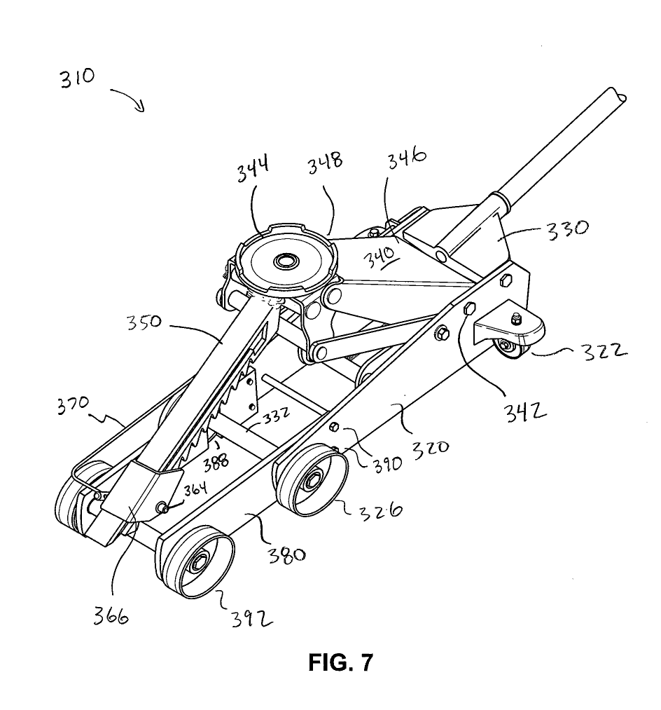

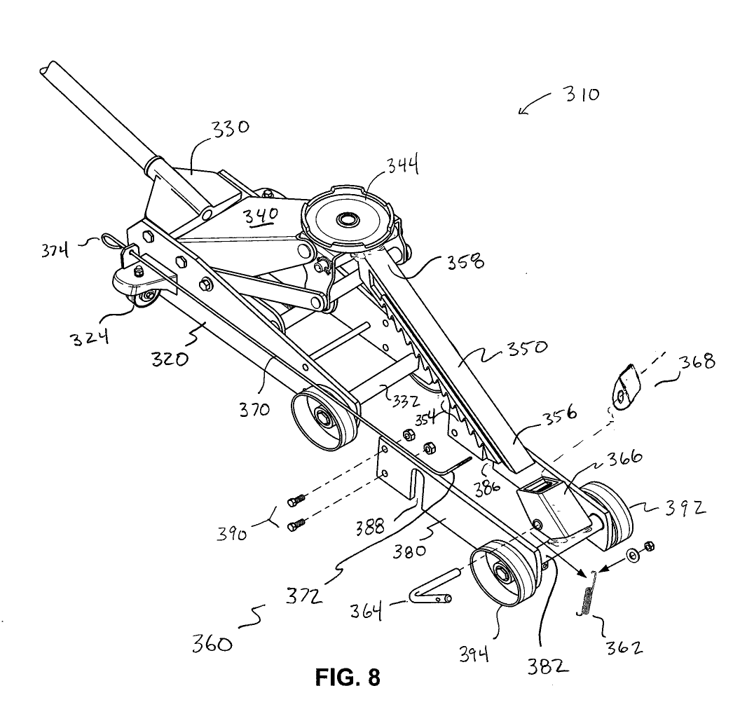

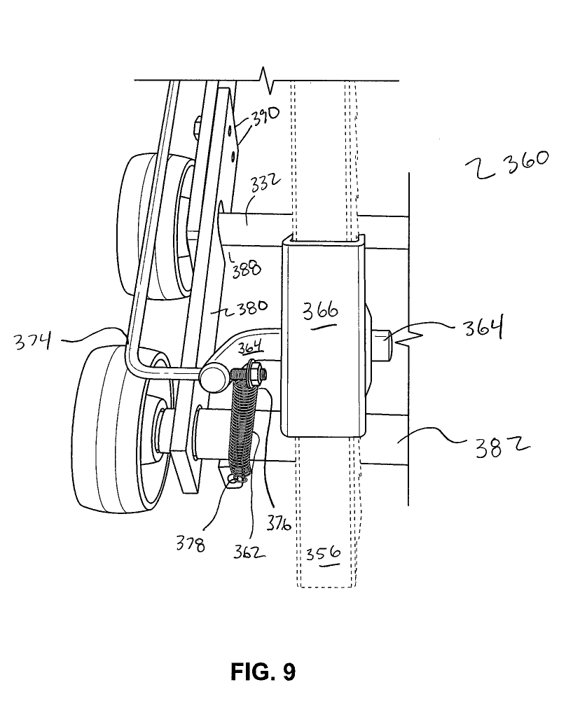

Referring to FIGS. 5-9, a second embodiment of an improved safety jack system 310 is shown, including a jack 312 having a base 320, an operator 330, a head 344, and a movable jack arm 340 with first end 346 connected to jack base 320 at a joint 342 and second end 348 connected to jack head 344, a locking arm base 360 coupled to jack base 320, the locking arm base 360 including a linear guide 366 pivotably coupled to the locking arm base 360, a releasable locking mechanism 368 engagable with a locking arm 350; a release operator 364 coupled to releasable locking mechanism 368, and a locking arm 350 having first and second ends, 356 and 358 respectively, and a plurality of locking mechanism engagement points 354 distributed along at least a portion of locking arm 350, with locking arm 350 movably connectable at first end 356 to linear guide 366 and pivotably connectable at second end 358 to jack head 344. In the embodiment engagement points 354 are locking teeth for engaging a pawl or similar mechanical locking mechanism. Locking teeth 354 are distributed along at least a portion of the length of locking arm 350 to provide a range of selectable locking heights.

In the embodiment, linear guide 366 is a sleeve within which locking arm 350 slides during elevation or depression of jack arm 340. Locking arm first end 356 is pivotably connected to jack head 344 by sleeve coupling 352, which is coaxially mounted over cotter pin 353.

In the embodiment jack 312 is a cantilevered mechanical jack, base 320 includes an elongated support frame on rollers 322, 324, 326 and 328, operator 330 is an elongated handle accessible to the operator, and jack head 344 includes a plate for engaging the frame of a vehicle. In the embodiment, movable jack arm 344 is cantilevered so that it can recess into base 320 to lower the profile of the jack. Rollers 322 and 324 are preferably steerable.

Referring again to FIGS. 5-9, in an embodiment a remote release operator 370 is provided, having a first end 372 coupled to release operator 364 and a second end 374 located proximal to jack operator 330, allowing the user to operate the jack and the locking mechanism from a single location. In the embodiment, locking mechanism 368 is a pawl coaxially mounted with release operator 364 internally to linear guide 366, and locking mechanism engagement points 354 are teeth to engage pawl 368.

Referring again to FIGS. 5-9, locking mechanism 368 is preferably biased to the locked position by gravity, but biasing element 362 is provided to assist gravity, ensure proper seating, and prevent locking mechanism 368 from unlocking due to mechanical jarring. In the embodiment, biasing element 362 is a spring connected at a first end 376 to release operator 364 and at a second end 378 to an anchor point on locking arm base 360, which biases locking mechanism 368 in the engaged position to help ensure positive engagement between pawl 368 and teeth 354.

Referring again to FIGS. 5-9, in an embodiment locking arm base 360 includes an extension 380 removably coupled to jack base 320. Linear guide 366 is pivotably coupled to extension 380 using a sleeve coupling 382 which can mount coaxially over the axel of extension rollers 392 & 394. Extension 380 includes slots 386 and 388 which fit over shaft sleeve 332 containing the axel for rollers 326 and 328, and fasteners 390, which in the embodiment are threaded bolts. Extension 380 includes rollers 392 and 394, which allows the improved jack system 310 to be easily moved and set in place as a unified assembly.

Extension 380 permits a simple conversion of an existing jack to include an inherently safe locking arm 350. A user can simply connect extension 380 to an existing jack base 320 by hooking the slots 386 and 388 over shaft sleeve 332 and inserting fasteners 390 through the sides, inserting locking arm first end 356 into linear guide 366, and inserting cotter pin 353 through jack head 344 and sleeve coupling 352.

Pre-existing jacks to be converted will often not be long enough to incorporate a straight locking arm 350, because as the jack head is raised, the locking arm first end may become jammed against the floor. The additional length provided by extension 380 can prevent this, and allows a jack to be converted for use in situations where the inherently safe features are not required, and/or allows the system to be broken down for easier storage and transport.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. An improved safety jack system, comprising:
a jack including a base, an operator, a head, and a movable jack arm having a first end connected to said jack base and a second end connected to said jack head;
a locking arm base coupled to said jack base, said locking arm base comprising:
a linear guide pivotably coupled to said jack base;
a releasable locking mechanism engagable with a locking arm;
a release operator coupled to said releasable locking mechanism;
a locking arm having first and second ends and a plurality of locking mechanism engagement points distributed along at least a portion of said locking arm, said locking arm movably connectable at said first end to said linear guide and pivotably connectable at said second end to said jack head.

2. The improved jack system of claim 1, further comprising:
a remote release operator having a first end coupled to said release operator and a second end located proximal to said jack operator.

3. The improved jack system of claim 1, wherein said releasable locking mechanism further comprises a pawl and said plurality of locking mechanism engagement points further comprises a plurality of locking teeth.

4. The improved jack system of claim 1, further comprising:
a locking mechanism biasing element coupled to said releasable locking mechanism.

5. The improved jack system of claim 4, wherein said biasing element comprises a spring coupled between said release operator and a said locking arm base.

6. A locking arm for a jack, said jack a jack including a base, an operator, a head, and a movable jack arm having a first end connected to said jack base and a second end connected to said jack head;
a locking arm base couplable to said jack base, said locking arm base comprising:
a jack base extension removably connectable to said jack base;
a linear guide pivotably coupled to said extension;
a releasable locking mechanism engagable with a locking arm;
a release operator coupled to said releasable locking mechanism;
a locking arm having first and second ends and a plurality of locking mechanism engagement points distributed along at least a portion of said locking arm, said locking arm movably connectable at said first end to said linear guide and pivotably connectable at said second end to said jack head.

7. The locking arm of claim 6, further comprising:
a remote release operator having a first end coupled to said release operator and a second end positionable proximal to said jack operator.

8. The locking arm of claim 6, wherein said releasable locking mechanism further comprises a pawl and said plurality of locking mechanism engagement points further comprises a plurality of locking teeth.

9. The locking arm of claim 6, further comprising:
a locking mechanism biasing element coupled to said releasable locking mechanism.

10. The locking arm of claim 9, wherein said biasing element comprises a spring coupled between said release operator and a said locking arm base.

11. The locking arm of claim 6, wherein said extension further includes at least one support roller.

12. An improved safety jack system, comprising:
a jack including a base, an operator, a head, and a movable jack arm having a first end connected to said jack base and a second end connected to said jack head;
a locking arm base couplable to said jack base, said locking arm base comprising:
a jack base extension removably connectable to said jack base, said extension including at least one support roller;
a linear guide pivotably coupled to said extension;
a releasable locking mechanism engagable with a locking arm;
a release operator coupled to said releasable locking mechanism;
a locking mechanism biasing element coupled to said releasable locking mechanism
a remote release operator having a first end coupled to said release operator and a second end positionable proximal to said jack operator;
a locking arm having first and second ends and a plurality of locking mechanism engagement points distributed along at least a portion of said locking arm, said locking arm movably connectable at said first end to said linear guide and pivotably connectable at said second end to said jack head.

13. The locking arm of claim 12, wherein said releasable locking mechanism further comprises a pawl and said plurality of locking mechanism engagement points further comprises a plurality of locking teeth.

14. The locking arm of claim 12, wherein said biasing element comprises a spring coupled between said release operator and a said locking arm base.
